(19) United States
(12) Patent Application Publication
(10) Pub. No.: US 2015/0189495 A1
(43) Pub. Date: Jul. 2, 2015

(54) PROVIDING DEVICE-TO-DEVICE CONNECTIVITY BY DETERMINING COMMUNICATION PREFERENCES IN REAL-TIME

(71) Applicant: Verizon Patent and Licensing Inc., Basking Ridge, NJ (US)

(72) Inventors: Zhong CHEN, Acton, MA (US); Theodore G. Poppe, Quincy, MA (US); Aiqun Guo, Weston, MA (US); Bryce Schadl, Ashland, MA (US); Bilal Wahid, Bedford, MA (US)

(73) Assignee: Verizon Patent and Licensing Inc., Basking Ridge, NJ (US)

(21) Appl. No.: 14/145,334

(22) Filed: Dec. 31, 2013

(51) Int. Cl. H04W 8/18; H04W 76/02; H04W 4/00

(52) U.S. Cl. CPC H04W 8/183; H04W 4/005; H04W 76/023; H04W 88/04

(57) ABSTRACT

A device may determine a condition for providing customer information to a mobile device. The device may detect the mobile device, and may request, from the mobile device and based on detecting the mobile device, information that identifies a user communication preference associated with providing the customer information to the mobile device. The device may receive, from the mobile device and based on the request, the information that identifies the user communication preference. The device may determine whether the customer information is to be provided to the mobile device based on the user communication preference and the condition, and may selectively provide the customer information and an instruction to the mobile device based on determining whether the customer information is to be provided to the mobile device. The instruction may cause the mobile device to relay the customer information to a network storage device.

### BACKGROUND

Device-to-device communication, or machine-to-machine communication, may refer to technologies that allow devices to communicate with minimal or no input by a user. As an example of device-to-device communication, a first device may capture an event, and may relay information associated with the event, through a network, to a second device. The second device may execute an application to analyze the information to generate a result, and may provide the result (e.g., for display to a user, to control the first device, etc.).

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for determining whether a mobile device is approved to receive customer information;

FIGS. 5A and 5B are diagrams of an example implementation relating to the example process shown in FIG. 4;

FIG. 6 is a flow chart of an example process for determining whether to provide customer information to a mobile device, for transmission to a network storage device, based on a customer-specified condition and/or a user communication preference; and

FIGS. 7A-7D are diagrams of an example implementation relating to the example process shown in FIG. 6.

### DETAILED DESCRIPTION OF PREFERRED EMBODIMENTS

The following detailed description of example implementations refers to the accompanying drawings. The same reference numbers in different drawings may identify the same or similar elements.

A customer of a network service provider may desire to upload information, from customer storage devices that store the information, to a network storage device for aggregation and/or analysis. For example, a vending machine operator may want inventory levels of vending machines to be uploaded to the network storage device so that the vending machine operator can manage restocking of the vending machines. However, the customer may not want to maintain an expensive network connection (e.g., a cellular connection) on each customer storage device. Furthermore, different customers may have different preferences regarding what information is uploaded, when the information is uploaded, how the information is uploaded, etc. Implementations described herein allow customers of a network service provider to upload information from customer storage devices to a network storage device based on the customer's preferences and without maintaining an expensive network connection.

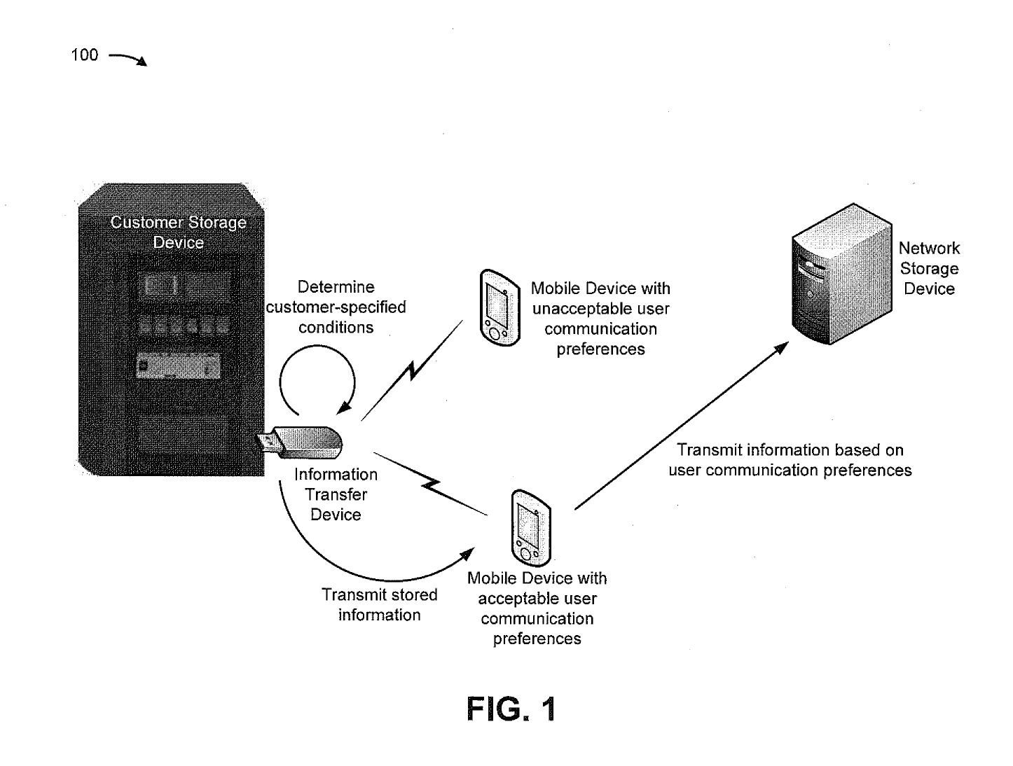

FIG. 1 is a diagram of an overview of an example implementation 100 described herein. As shown in FIG. 1, a customer storage device, such as a vending machine, a cash register, or the like, may store information that a customer wants to analyze. The customer storage device may be connected to an information transfer device, such as a thumb drive, a dongle, or the like, that connects to the customer storage device via an interface of the customer storage device (e.g., via an Ethernet interface, a universal serial bus (USB) interface, etc.). The information transfer device may detect nearby mobile devices (e.g., smart phones, tablets, etc.).

As further shown in FIG. 1, the information transfer device may determine customer-specified conditions that may identify, for example, which mobile devices are permitted to receive stored information (e.g., stored by the customer storage device), when a mobile device is to upload the information to the network storage device, a type of stored information to be transmitted to a mobile device, etc. The information transfer device may detect a nearby mobile device, and may determine user communication preferences associated with the mobile device. For example, a user of the mobile device may specify preferences regarding whether to accept information, when to upload the information to the network storage device, etc.

The information transfer device may compare the user communication preferences and the customer-specified conditions to determine whether the mobile device is associated with acceptable user communication preferences or unacceptable user communication preferences (e.g., whether the customer-specified conditions are satisfied). The information transfer device may transmit stored information (e.g., stored by the customer storage device), to a mobile device with acceptable user communication preferences. The mobile device may receive the information, and may transmit the information to the network storage device based on the user communication preferences and/or the customer-specified conditions. For example, the mobile device may transmit the information immediately, may transmit the information during off-peak hours, may transmit the information when connected to a Wi-Fi network, etc.

In this way, a customer may utilize nearby mobile devices to transfer information stored on a customer storage device to a network storage device, rather than paying for an expensive direct connection to the network storage device. The customer may also ensure that the information is transferred according to the customer's preferences. Furthermore, users of the mobile devices may benefit by receiving incentives for allowing the users' mobile devices to be used to transfer information to the network storage device, and may control the manner in which the information is transferred by specifying user communication preferences.

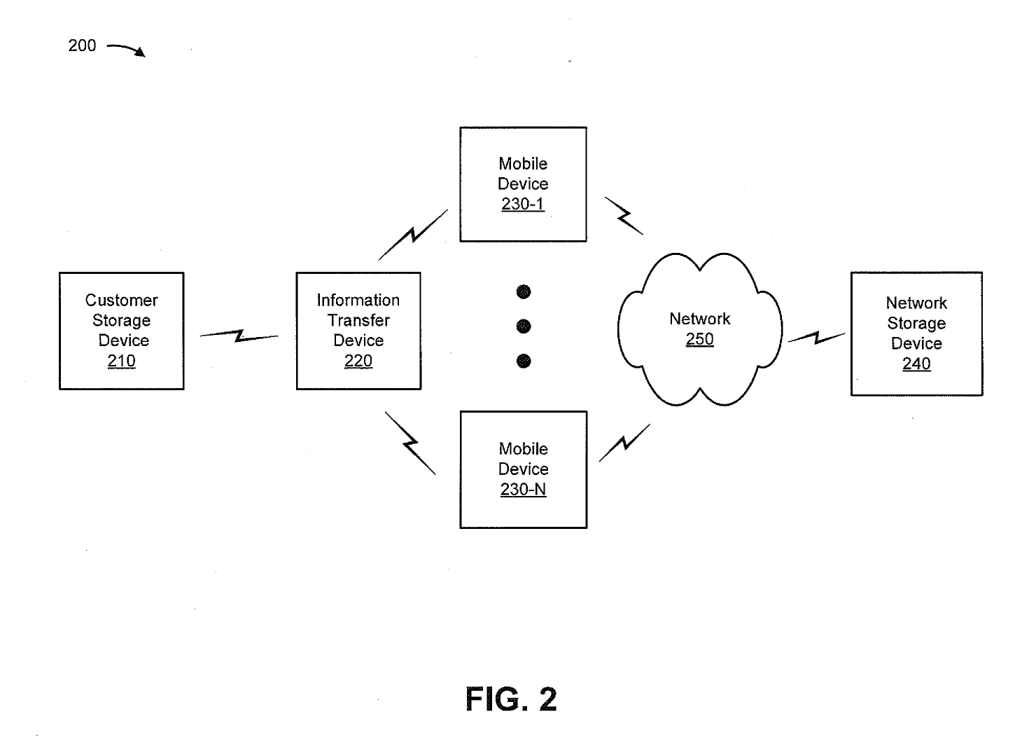

FIG. 2 is a diagram of an example environment 200 in which systems and/or methods described herein may be implemented. As shown in FIG. 2, environment 200 may include a customer storage device 210, an information transfer device 220, one or more mobile devices 230-1 through 230-N(N≧1) (hereinafter referred to individually as “mobile device 230,” and collectively as “mobile devices 230”), a network storage device 240, and a network 250. Devices of environment 200 may interconnect via wired connections, wireless connections, or a combination of wired and wireless connections.

Customer storage device 210 may include one or more devices capable of receiving, generating, and/or processing information, storing the information, and providing the information for transfer to network storage device 240 via mobile device 230. For example, customer storage device 210 may include a vending machine, a point-of-sale device (e.g., a cash register), a device with one or more sensors (e.g., a temperature sensor, a light sensor, a power sensor, etc.), a television, a computer, a video-recording device, an audio-recording device, etc. Customer storage device 210 may be associated with a customer of a service provider that provides a service for uploading information, stored by customer storage device 210, to network storage device 240. Customer storage device 210 may be associated with one or more customer-specified conditions that control a manner in which the stored information is provided for uploading to network storage device 240.

Information transfer device 220 may include one or more devices capable of providing information, stored by customer storage device 210, to mobile device 230 for transmission to network storage device 240. For example, information transfer device 220 may include a device that provides a communication interface between customer storage device 210 and mobile device 230, such as a dongle, a thumb drive, a wired hotspot, a wireless hotspot, a bridge, etc. Information transfer device 220 may detect and/or connect to customer storage device 210 via a wired and/or wireless interface, such as an Ethernet interface, a USB interface, a serial interface, a Wi-Fi interface, a Bluetooth interface, or the like. Information transfer device 220 may connect to mobile device 230 via a wireless interface (e.g., an air interface), such as a Wi-Fi interface, a Bluetooth interface, a radio interface, a Zigbee interface, or the like. Information transfer device 220 may determine one or more customer-specified conditions associated with customer storage device 210, may determine one or more user communication preferences associated with mobile device 230, and may determine whether to transfer information to mobile device 230 based on the customer-specified conditions and/or the user communication preferences.

Mobile device 230 may include one or more devices capable of receiving information from information transfer device 220, storing the information, and/or providing the information to network storage device 240 based on one or more preferences and/or conditions. For example, mobile device 230 may include a mobile phone, a smart phone, a radiotelephone, a personal communications systems (PCS) terminal, a personal digital assistant (PDA), a tablet computer, a laptop computer, or a similar device. Mobile device 230 may receive information that identifies one or more user communication preferences and/or customer-specified conditions, and may provide information, received from information transfer device 220, to network storage device 240 based on the preferences and/or conditions.

Network storage device 240 may include one or more devices capable of receiving, via information transfer device 220 and/or mobile device 230, information generated by customer storage device 210. For example, network storage device 240 may include a computing device, such as a server device, a computer, or the like. Network storage device 240 may analyze, process, and/or provide the received information (e.g., for display and/or to another device).

Network 250 may include one or more wired and/or wireless networks. For example, network 250 may include a cellular network (e.g., a long-term evolution (LTE) network, a code division multiple access (CDMA) network, a fourth generation (4G) network, a third generation (3G) network, etc.), a public land mobile network (PLMN), a Wi-Fi network, a local area network (LAN), a wide area network (WAN), a metropolitan area network (MAN), a telephone network (e.g., the Public Switched Telephone Network (PSTN)), an ad hoc network, an intranet, the Internet, a fiber optic-based network, and/or a combination of these or other types of networks.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

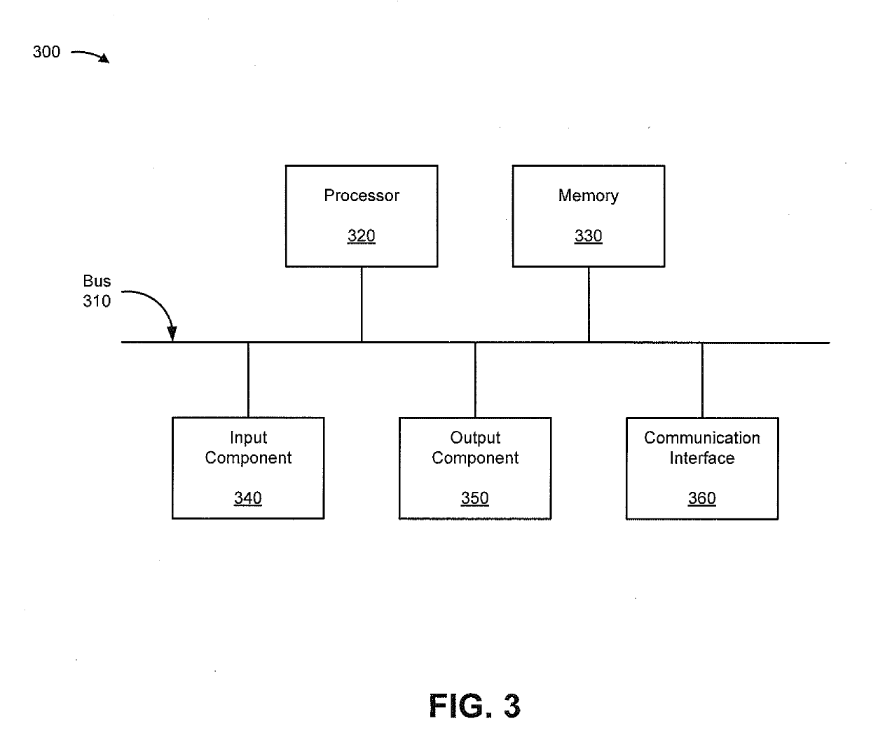

FIG. 3 is a diagram of example components of a device 300. Device 300 may correspond to customer storage device 210, information transfer device 220, mobile device 230, and/or network storage device 240. In some implementations, each of customer storage device 210, information transfer device 220, mobile device 230, and/or network storage device 240 may include one or more devices 300 and/or one or more components of device 300. As shown in FIG. 3, device 300 may include a bus 310, a processor 320, a memory 330, an input component 340, an output component 350, and a communication interface 360.

Bus 310 may include a component that permits communication among the components of device 300. Processor 320 may include a processor (e.g., a central processing unit, a graphics processing unit, an accelerated processing unit), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a USB interface, a Wi-Fi interface, a cellular network interface, or the like.

Device 300 may perform one or more processes described herein. Device 300 may perform these processes in response to processor 320 executing software instructions included in a computer-readable medium, such as memory 330. A computer-readable medium is defined herein as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, one or more of the components of device 300 may perform one or more functions described as being performed by another one or more components of device 300.

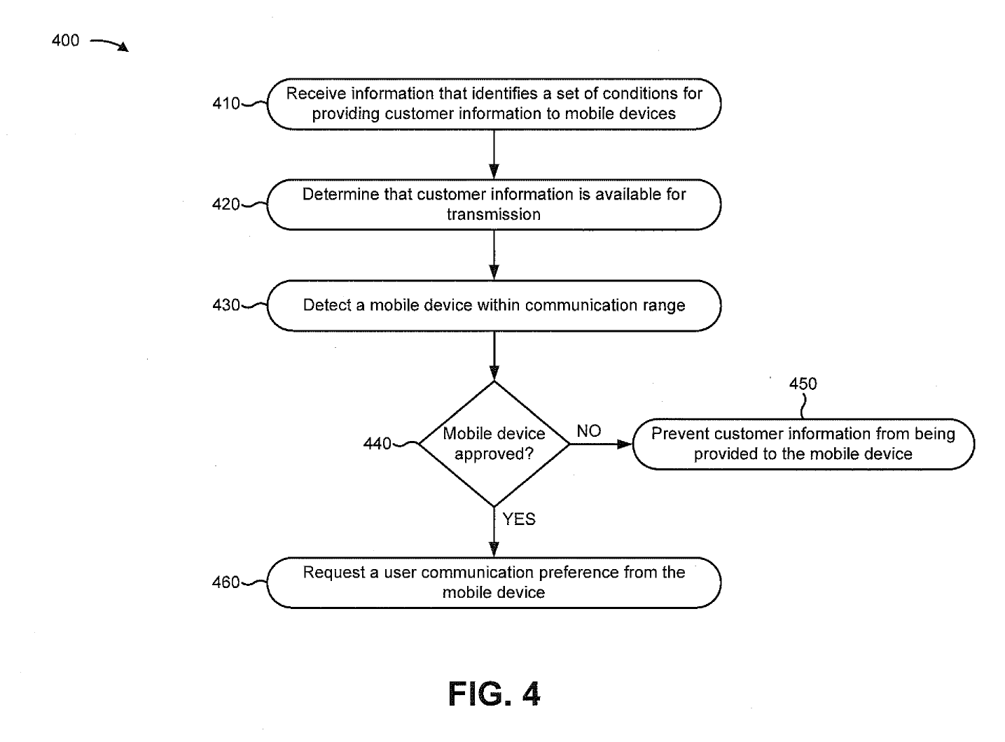

FIG. 4 is a flow chart of an example process 400 for determining whether a mobile device is approved to receive customer information. In some implementations, one or more process blocks of FIG. 4 may be performed by information transfer device 220. Additionally, or alternatively, one or more process blocks of FIG. 4 may be performed by another device or a group of devices separate from or including information transfer device 220, such as customer storage device 210, mobile device 230, and/or network storage device 240.

As shown in FIG. 4, process 400 may include receiving information that identifies a set of conditions for providing customer information to mobile devices (block 410). For example, information transfer device 220 may be programmed, using an input device, to identify one or more customer conditions that must be satisfied for customer information to be provided to mobile device 230. The input device may correspond to customer storage device 210, or may be a different device than customer storage device 210. For example, information transfer device 220 may be programmed prior to being connected to customer storage device 210. A customer may provide input to identify the set of conditions, which may be provided to information transfer device 220. In some implementations, the set of conditions may be specified in a service level agreement (SLA) between the customer and a network service provider.

A condition may identify one or more mobile devices 230 permitted to receive information stored by customer storage device 210 (sometimes referred to herein as customer information), in some implementations. For example, a condition may identify a type of mobile device 230 (e.g., a smart phone, a tablet, a particular model of smart phone, a mobile device 230 associated with an employee of the customer, a mobile device 230 associated with a non-employee of the customer, etc.) permitted to receive the customer information. As another example, a condition may identify one or more device identifiers associated with a particular mobile device 230 permitted to receive the customer information. A device identifier may include, for example, a mobile directory number (MDN), a subscriber identity module (SIM) uniform resource identifier (URI), a mobile identification number (MIN), an international mobile subscriber identity (IMSI), a mobile subscriber integrated services digital network (MSISDN) identifier, a national access identifier (NAI), etc.

A condition may identify a type of customer information to be provided to mobile device 230 for uploading to network storage device 240, in some implementations. Customer storage device 210 may receive, generate, and/or store a variety of types of information, such as repair information, status information, inventory information, sales information, interaction information, traffic information, location information, demographic information, etc. A condition may identify one or more types of information to be provided to mobile device 230, in some implementations. Customer storage device 210 and/or information transfer device 220 may associate metadata with stored information, and may use the metadata to identify a type of the information.

Additionally, or alternatively, a condition may identify a delivery requirement for when the customer information is to be uploaded by mobile device 230 to network storage device 240. For example, a condition may indicate that the customer information is to be uploaded immediately (e.g., as soon as mobile device 230 receives the customer information). As another example, a condition may indicate that the customer information is to be uploaded within a threshold period of time after mobile device 230 receives the customer information (e.g., one minute, one hour, one day, etc.). As another example, a condition may indicate that the customer information may be uploaded during off-peak hours (e.g., within a particular time period), may be uploaded when mobile device 230 is connected to a particular type of network (e.g., a Wi-Fi network, an LTE network, etc.), or the like. As another example, a condition may indicate that customer information may be uploaded based on a user communication preference associated with a particular mobile device 230 to which the customer information is provided. In some implementations, a condition may identify different delivery requirements for different types of customer information.

A condition may identify an amount of customer information to be provided to a particular mobile device 230 for uploading to network storage device 240. For example, the condition may identify a maximum amount (e.g., a cap) of customer information that is permitted to be provided to a particular mobile device 230 during a single session and/or over multiple sessions (e.g., within a particular period of time). As another example, the condition may identify a minimum amount (e.g., a threshold) of customer information required to be available for transmission before any customer information may be transmitted. The identified amount(s) may be based on a compressed size of the customer information, an uncompressed size of the customer information, an amount of storage space required to store the customer information, etc.

In some implementations, a condition may identify one or more selection criteria for selecting one or more mobile devices 230 to receive customer information when information transfer device 220 detects multiple mobile devices 230 capable of receiving the customer information, as described in more detail below.

In some implementations, a first condition may depend on a second condition. For example, a delivery requirement for customer information may depend on a type of customer information (e.g., different types of information may have different delivery requirements), a minimum and/or maximum amount of customer information may depend on a type of customer information and/or a mobile device 230 that is to receive the information, a selection criteria may depend on a type of mobile device 230 and/or a type of customer information, etc.

As further shown in FIG. 4, process 400 may include determining that customer information is available for transmission (block 420). For example, information transfer device 220 may determine that customer storage device 210 has stored information that is ready to be transmitted to mobile device 230. In some implementations, information transfer device 220 may receive a notification, from customer storage device 210, indicating that customer storage device 210 is ready to transmit information. Additionally, or alternatively, information transfer device 220 may periodically check whether customer storage device 210 has stored information that is ready to transmit (e.g., once an hour, once a day, etc.).

In some implementations, information transfer device 220 may determine that the customer information is ready for transmission based on a threshold amount of customer information being stored by customer storage device 210 (e.g., a threshold based on a memory size of the customer information, a threshold based on a storage capacity of customer storage device 210, etc.).

As further shown in FIG. 4, process 400 may include detecting a mobile device within communication range (block 430). For example, information transfer device 220 may detect one or more mobile devices 230 within communication range of information transfer device 220. Information transfer device 220 may detect mobile device 230 by, for example, detecting a wireless radio signal, such as a Bluetooth signal, a Wi-Fi signal, a near-field communication signal, etc.

As further shown in FIG. 4, process 400 may include determining whether the mobile device is approved to receive the customer information (block 440). For example, information transfer device 220 may receive an indication of whether mobile device 230 is approved to receive the customer information. In some implementations, the indication may be based on information that identifies mobile device 230 (e.g., a device identifier). For example, information transfer device 220 may receive a device identifier from mobile device 230, and may compare the device identifier to a set of approved device identifiers identified by the set of conditions to determine whether mobile device 230 is approved to receive the customer information. In some implementations, information transfer device 220 may receive information that indicates whether mobile device 230 has stored and/or is executing an application associated with receiving customer information from information transfer device 220 and/or providing the information to network storage device 240.

Additionally, or alternatively, information transfer device 220 may receive, from mobile device 230, an indication of whether mobile device 230 is available to receive the customer information. For example, the indication may indicate whether mobile device 230 accepts customer information (e.g., whether a user, associated with mobile device 230, has opted-in to receive customer information), may indicate whether mobile device 230 has received a threshold amount of customer information (e.g., within a particular time period) and is not accepting any more customer information, etc. In some implementations, the indication may be based on a user communication preference, as described elsewhere herein.

If the mobile device is not approved to receive the customer information (block 440—NO), then process 400 may include preventing the customer information from being provided to the mobile device (block 450). For example, if information transfer device 220 determines that mobile device 230 is not accepting customer information, is not associated with an approved device identifier, etc., then information transfer device 220 may prevent the customer information from being transmitted to mobile device 230.

If the mobile device is approved to receive the customer information (block 440—YES), then process 400 may include requesting a user communication preference from the mobile device (block 460). For example, if information transfer device 220 determines that mobile device 230 is accepting customer information, is associated with an approved device identifier, etc., then information transfer device 220 may request one or more user communication preferences from mobile device 230. Information transfer device 220 may use the user communication preferences to determine whether to transmit customer information to mobile device 230, as described in more detail elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

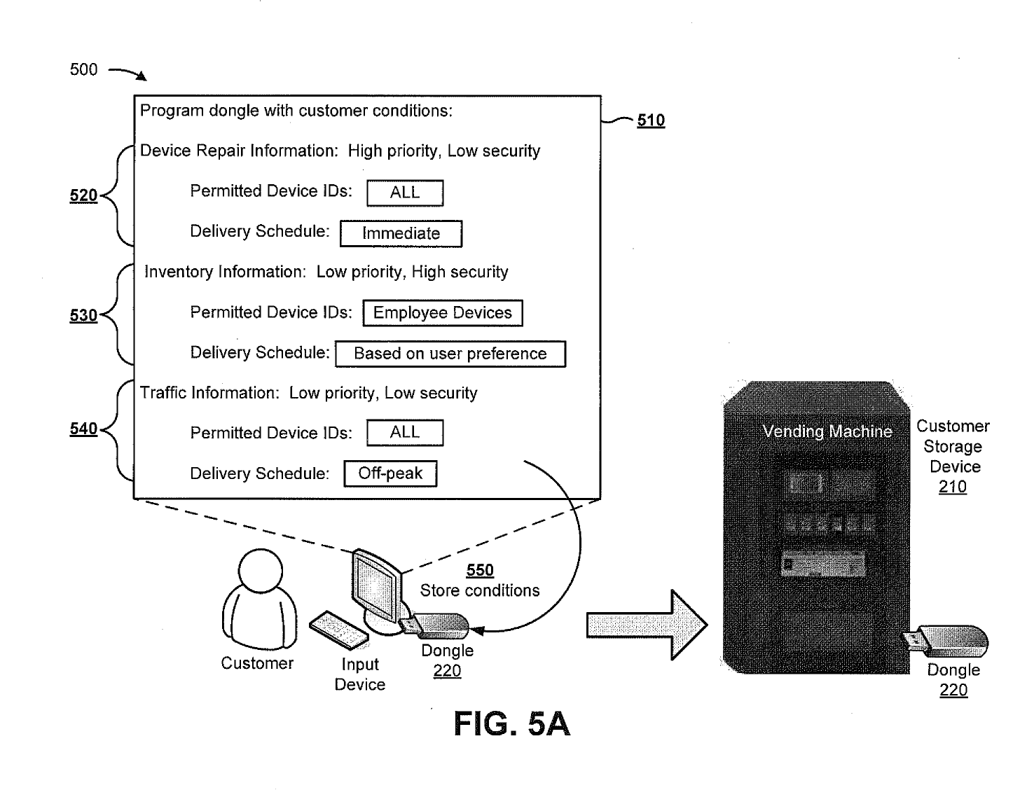

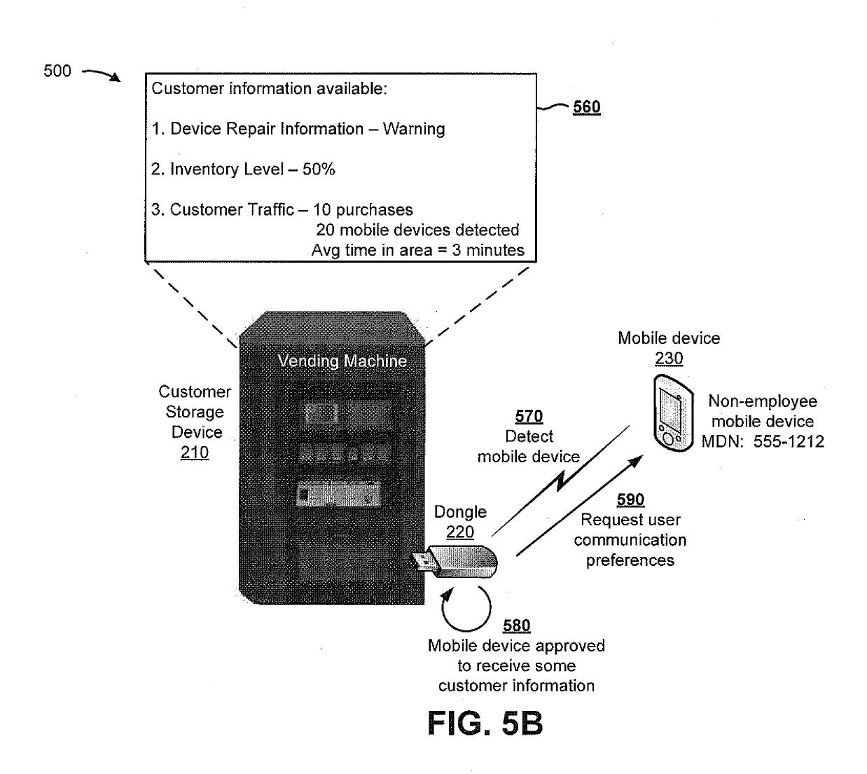

FIGS. 5A and 5B are diagrams of an example implementation 500 relating to example process 400 shown in FIG. 4. FIGS. 5A and 5B show an example of programming information transfer device 220, shown as dongle 220, with a set of conditions, and using the set of conditions to determine whether a mobile device is approved to receive customer information stored by customer storage device 210.

As shown in FIG. 5A, and by reference number 510, a customer may interact with an input device to program dongle 220 with a set of conditions for providing customer information to mobile device 230. For example, the customer may identify one or more types of customer information to be provided to mobile device 230. As shown in FIG. 5A, assume that the types of customer information include device repair information, inventory information, and traffic information.

As further shown in FIG. 5A, assume that the customer identifies different delivery requirements and different security levels for the different types of customer information. As shown by reference number 520, assume that the customer identifies that the device repair information is approved for transmission to all mobile devices 230 that are available to immediately upload the device repair information to network storage device 240. As shown by reference number 530, assume that the customer identifies that the inventory information is approved for transmission to employee mobile devices 230 (e.g., devices with a device identifier that matches a stored device identifier associated with an employee of the customer), and that the inventory information is to be uploaded to network storage device 240 based on a user preference specified by a user of employee mobile device 230. As shown by reference number 540, assume that the customer identifies that the traffic information is approved for transmission to all mobile devices 230, and that mobile devices 230 that receive the traffic information are to upload the traffic information to network storage device 240 during off-peak hours.

As shown by reference number 550, the input set of conditions are stored by dongle 220. As further shown, the dongle is communicatively connected to customer storage device 210, such as via a USB interface.

As shown in FIG. 5B, assume that dongle 220 determines that customer storage device 210 has customer information available for transmission to mobile device 230. As shown by reference number 560, assume that the customer information includes device repair information indicating that there is a device repair warning, inventory information that indicates that inventory levels are at 50% of capacity, and traffic information that indicates that customers have made ten purchases from the vending machine, and that 20 mobile devices have been detected by dongle 220 (e.g., in a particular time period).

As shown by reference number 570, assume that dongle 220 detects mobile device 230. Assume that mobile device 230 is a non-employee mobile device with a mobile directory number (MDN) of 555-1212. As shown by reference number 580, dongle 220 determines that mobile device 230 is approved to receive some of the stored customer information. As shown by reference number 590, dongle 220 requests user communication preferences from mobile device 230.

As indicated above, FIGS. 5A and 5B are provided merely as an example. Other examples are possible and may differ from what was described with regard to FIGS. 5A and 5B.

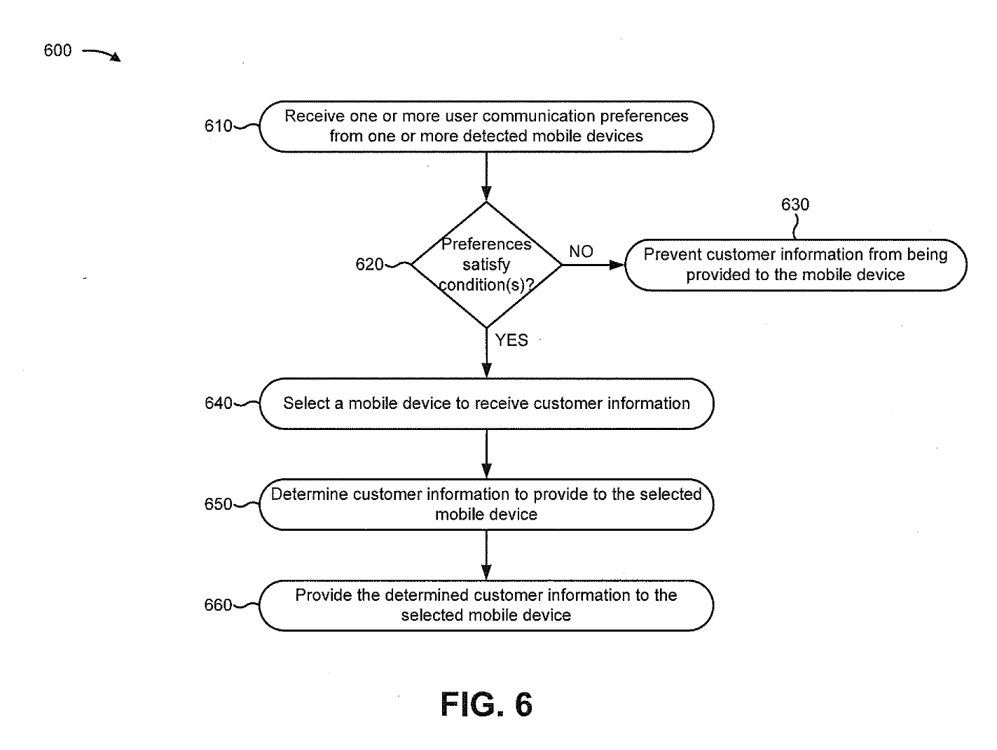

FIG. 6 is a flow chart of an example process 600 for determining whether to provide customer information to a mobile device, for transmission to a network storage device, based on a customer-specified condition and/or a user communication preference. In some implementations, one or more process blocks of FIG. 6 may be performed by information transfer device 220. Additionally, or alternatively, one or more process blocks of FIG. 6 may be performed by another device or a group of devices separate from or including information transfer device 220, such as customer storage device 210, mobile device 230, and/or network storage device 240.

As shown in FIG. 6, process 600 may include receiving one or more user communication preferences from one or more detected mobile devices (block 610), and determining whether the user communication preferences satisfy one or more conditions (block 620). For example, a user of mobile device 230 may input information that identifies one or more user communication preferences associated with receiving customer information from information transfer device 220 and/or associated with providing the customer information to network storage device 240. The user may input the user communication preferences using mobile device 230 and/or using another device that provides the information to mobile device 230.

A user communication preference may indicate, for example, whether to accept customer information, such as whether to accept any customer information, whether to accept a particular type of customer information, whether to accept customer information associated with a particular delivery requirement, etc. In some implementations, a default user communication preference may be set to not accept customer information, and a user may be required to opt-in to receive customer information for uploading to network storage device 240.

Additionally, or alternatively, a user communication preference may identify when to upload received customer information to network storage device 240 (e.g., immediately, within a threshold period of time after receiving the information, during a particular time period, such as during off-peak hours, when connected to a particular type of network, etc.).

In some implementations, a user communication preference may identify an amount of customer information to accept (e.g., a maximum amount) during a single communication session and/or across multiple communication sessions. Additionally, or alternatively, a user communication preference may identify an amount of customer information to accept from a particular information transfer device 220 and/or from multiple information transfer devices 220. In some implementations, a user communication preference may identify a maximum amount of storage space, on mobile device 230, to be used to store customer information.

Information transfer device 220 may determine whether the user communication preferences satisfy the set of conditions. For example, information transfer device 220 may compare a preference that identifies a delivery requirement, a type of customer information, a size of customer information, etc., to a set of conditions.

If the user communication preferences do not satisfy the set of conditions (block 620—NO), then process 600 may include preventing customer information from being provided to the mobile device (block 630). For example, if information transfer device 220 determines that mobile device 230 is associated with an unacceptable user preference (e.g., based on the set of conditions), then information transfer device 220 may prevent customer information from being provided to mobile device 230.

As an example, assume that the set of conditions identifies a delivery requirement indicating that customer information is to be uploaded immediately. Further, assume that a user communication preference indicates that a particular mobile device 230 is to upload information when connected to a home WiFi network. In this case, information transfer device 220 may prevent the customer information from being provided to the particular mobile device 230.

If the user communication preferences satisfy the set of conditions (block 620—YES), then process 600 may include selecting a mobile device to receive customer information (block 640), and determining customer information to provide to the selected mobile device (block 650). For example, information transfer device 220 may select one or more mobile devices 230, from a set of mobile devices 230 detected by information transfer device 220, and may determine customer information to provide to the one or more mobile devices 230.

In some implementations, information transfer device 220 may detect a single mobile device 230 within communication range, that is approved to receive customer information, and/or that is associated with user communication preferences that satisfy the set of conditions. In this case, information transfer device 220 may determine customer information to provide to the single mobile device 230 based on the user preferences and/or the set of conditions. For example, information transfer device 220 may determine customer information to provide based on a type of the information, a delivery requirement associated with the information, a size of the information, etc.

In some implementations, information transfer device 220 may detect multiple mobile devices 230 within communication range, that are approved to receive customer information, and/or that are associated with user communication preferences that satisfy the set of conditions. In this case, information transfer device 220 may select one or more mobile devices 230 to receive the customer information. Information transfer device 220 may compare user communication preferences associated with different mobile devices 230 to select a mobile device 230. For example, information transfer device 220 may compare delivery preferences associated with mobile devices 230, may compare device identifiers, may compare device types, etc., and may determine a mobile device 230 to receive the customer information based on the comparison.

Additionally, or alternatively, information transfer device 220 may compare characteristics associated with different mobile devices 230 to select a mobile device 230. For example, information transfer device 220 may compare a speed at which different mobile devices 230 are traveling, a location of different mobile devices 230, an amount of time that different mobile devices 230 have been in communication range of information transfer device 220, a signal strength of different mobile devices 230 (e.g., with information transfer device 220 and/or another device, such as a cellular base station), a direction in which the different mobile devices 230 are facing, a distance between different mobile devices 230 and information transfer device 220, etc. Information transfer device 220 may select a mobile device 230 based on the comparison.

Additionally, or alternatively, information transfer device 220 may determine first customer information to provide to a first mobile device 230, may determine second customer information to provide to a second mobile device 230, etc. In some implementations, the multiple sets of customer information may include the same information. In this way, information transfer device 220 may provide redundancy for information being transmitted to network storage device 240. In some implementations, information transfer device 220 may provide the customer information when information transfer device 220 has detected a threshold quantity of mobile devices 230.

Additionally, or alternatively, the multiple sets of customer information may include different information. For example, information transfer device 220 may determine different information to provide to different mobile devices 230 based on different user preferences associated with the different mobile devices 230. In some implementations, the multiple sets of customer information may not include any duplicate information. For example, information transfer device 230 may flag customer information that has been provided to a mobile device 230 so that the information is not provided again and/or so that the information is not provided more than a threshold quantity of times. In some implementations, the multiple sets of customer information may include some information that is the same and some information that is different.

Information transfer device 220 may prioritize the customer information for delivery to mobile device(s) 230, in some implementations. For example, the set of conditions may identify a first type of customer information that is to be provided first, a second type of customer information that is to be provided second, etc. Information transfer device 220 may determine an order for providing the customer information, based on the set of conditions, and may provide the customer information to mobile device(s) 230 based on the order.

In some implementations, information transfer device 220 may wait a threshold amount of time after providing customer information to a mobile device 230 before providing customer information (e.g., the same customer information, different customer information) again (e.g., to the same mobile device 230, to a different mobile device 230, etc.). Additionally, or alternatively, information transfer device 220 may receive an indication that the customer information has been received by network storage device 240. For example, network storage device 220 may provide the indication to mobile device 230 (e.g., in the vicinity of information transfer device 220), and mobile device 230 may provide the indication to information transfer device 220. Based on receiving the indication, information transfer device 220 may delete the customer information that has been received by network storage device 240 and/or may provide an instruction to customer storage device 210 to delete the customer information.

As further shown in FIG. 6, process 600 may include providing the determined customer information to the selected mobile device (block 660). For example, information transfer device 220 may provide customer information to one or more selected mobile devices 230. Additionally, or alternatively, information transfer device 230 may provide an instruction that causes mobile device 230 to provide the customer information to network storage device 240. The instruction may cause mobile device 230 to provide the information to network storage device 240 based on a delivery requirement and/or when a set of conditions is satisfied (e.g., at a particular time, when mobile device 230 is connected to a particular network, etc.). Mobile device 230 may provide the customer information to network storage device 240. Mobile device 230 may delete the customer information from a memory of mobile device 230 after providing the customer information to network storage device 240 and/or receiving an indication that network storage device 240 received the customer information.

In some implementations, information transfer device 220 may encrypt the customer information before the customer information is provided to mobile device 230. Additionally, or alternatively, mobile device 230 may encrypt the information and/or may securely store the customer information before the customer information is provided to network storage device 240.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

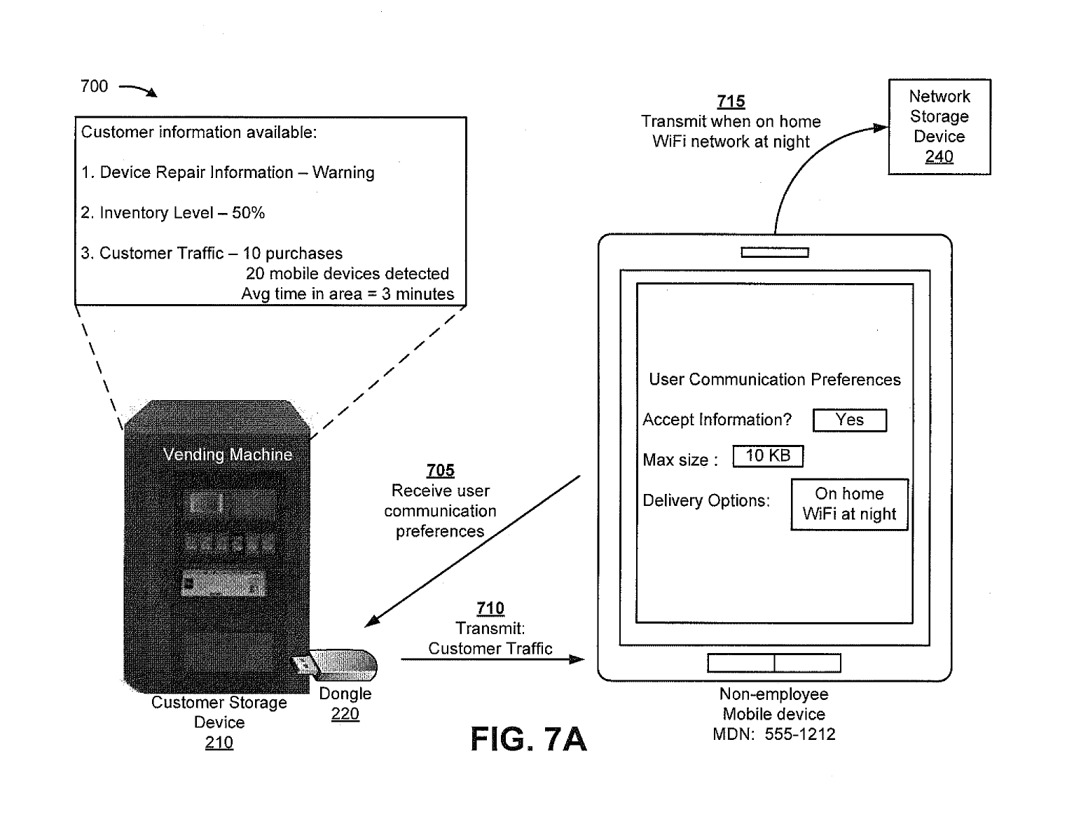

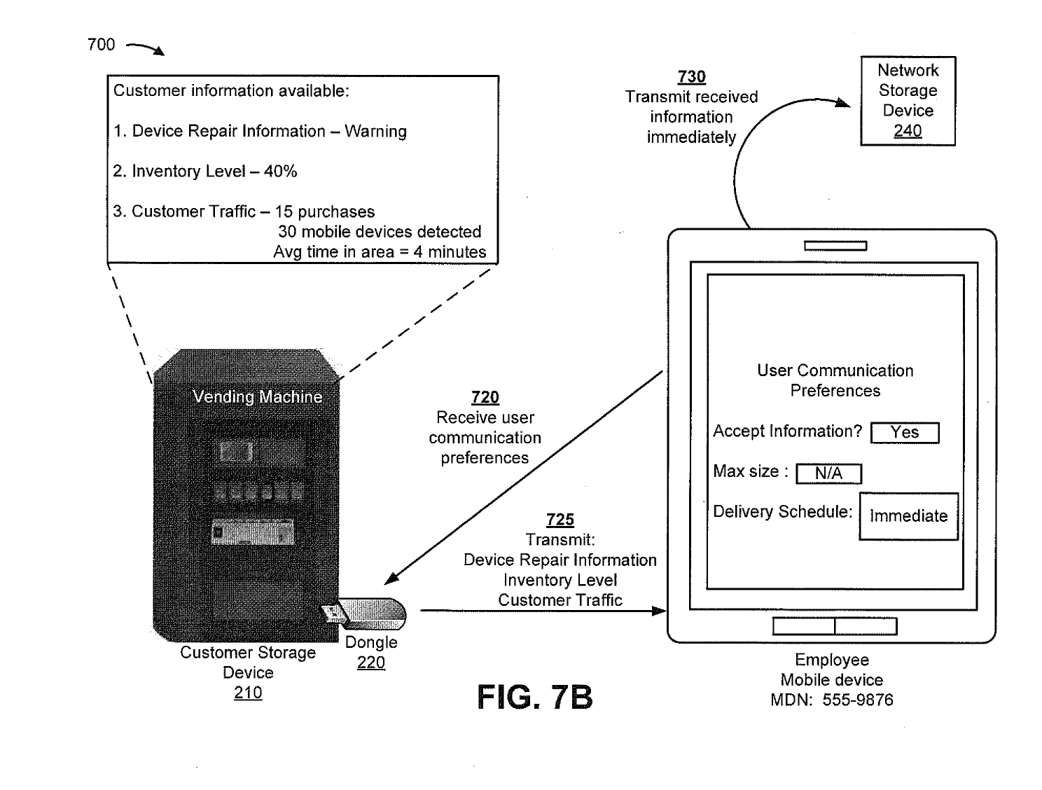

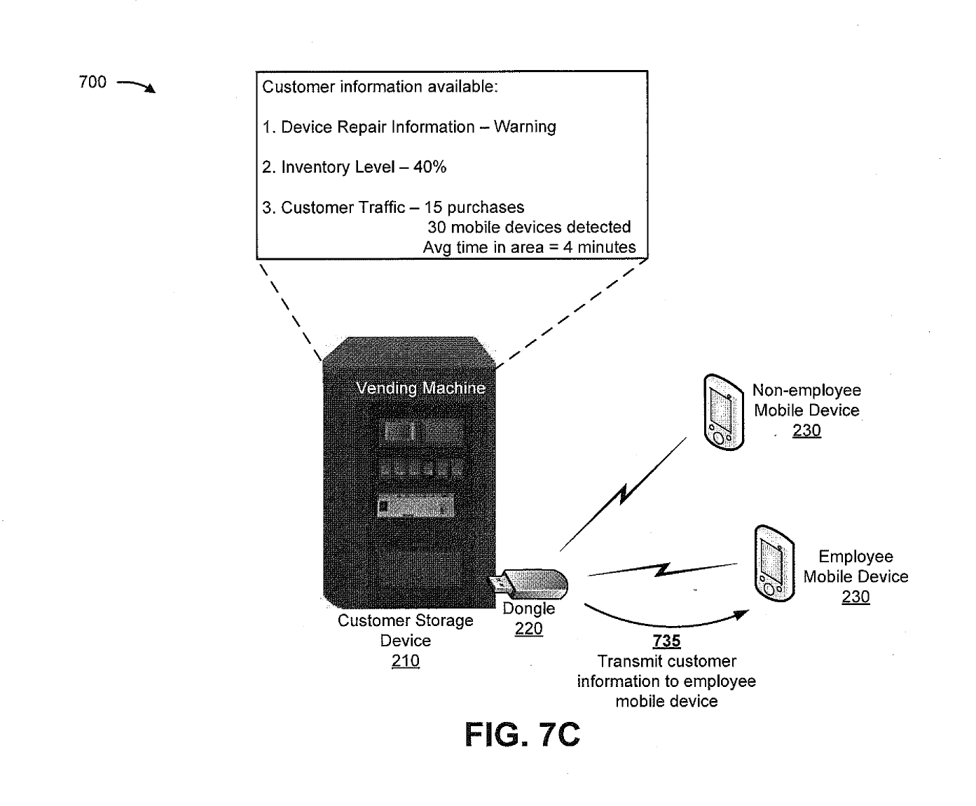

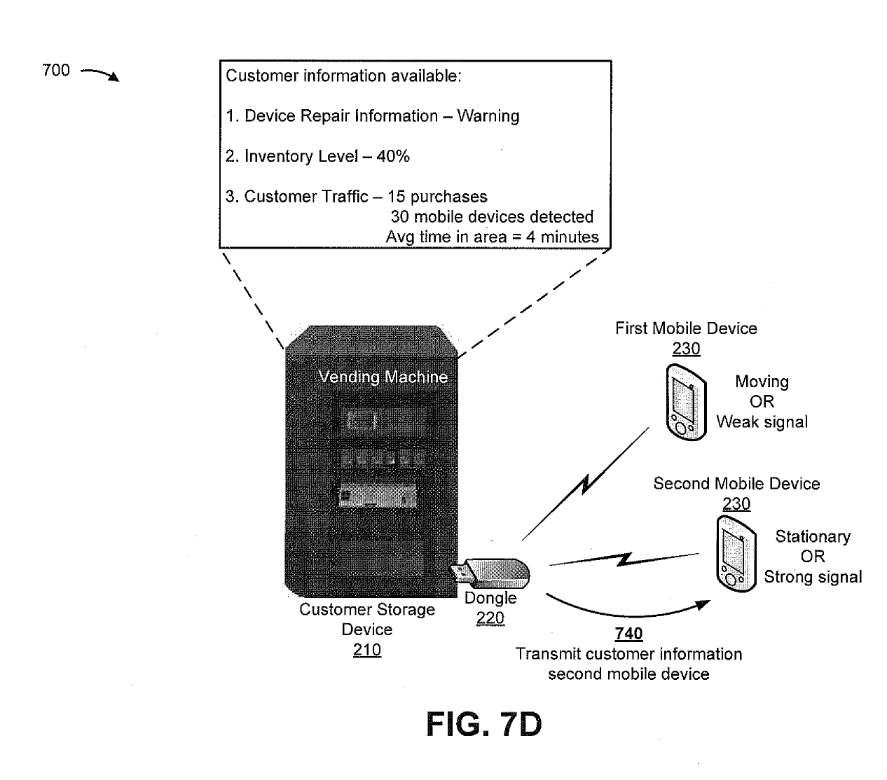

FIGS. 7A-7D are diagrams of an example implementation 700 relating to example process 600 shown in FIG. 6. FIGS. 7A-7D show an example of providing customer information to mobile device 230 based on user communication preferences. For the purpose of FIGS. 7A-7D, assume that information transfer device 220, shown as dongle 220, has performed the operations shown in FIGS. 5A and 5B, and has requested user communication preferences from mobile device 230.

As shown in FIG. 7A, and by reference number 705, assume that dongle 220 receives user communication preferences from non-employee mobile device 230 with an MDN of 555-1212. Assume that the user communication preferences include an indication to accept customer information, a maximum size of 10 kilobytes (KB) for received customer information, and an indication to deliver the customer information to network storage device 240 when mobile device 230 is connected to a home WiFi network at night.

Based on the user communication preferences, dongle 220 determines to transmit the customer traffic information to non-employee mobile device 230, as shown by reference number 710. Dongle 220 may make this determination based on a set of conditions, shown in FIG. 5A, indicating that the customer traffic information may be provided to any mobile device 230 capable of delivering the customer traffic information during off-peak hours. Assume that dongle 220 prevents device repair information from being provided to mobile device 230 because the device repair information may only be provided to mobile devices 230 that are capable of immediately providing the information to network storage device 240 (e.g., as shown in the set of conditions in FIG. 5A). Furthermore, assume that dongle 220 prevents inventory information from being provided to mobile device 230 because inventory information may only be provided to employee mobile devices 230 (e.g., as shown in the set of conditions in FIG. 5A). As shown by reference number 715, assume that non-employee mobile device 230 provides the customer traffic information to network storage 240 via a home WiFi network at night (e.g., during off-peak hours).

As shown in FIG. 7B, assume that at a later time, dongle 220 detects an employee mobile device 230 with an MDN of 555-9876. As shown by reference number 720, assume that dongle 220 receives user communication preferences from employee mobile device 230. Assume that the user communication preferences include an indication to accept customer information, no maximum size for received information, and an indication to deliver the customer information to network storage device 240 immediately (e.g., after employee mobile device 230 receives the information).

Based on the user communication preferences, dongle 220 determines to transmit the device repair information, the inventory information, and the customer traffic information to employee mobile device 230, as shown by reference number 725. Assume that dongle 220 determines to provide this information to employee mobile device 230 based on the user communication preferences, as well as the set of conditions shown in FIG. 5A. As shown by reference number 730, assume that employee mobile device 230 provides the received customer information to network storage 240 immediately after receiving the customer information.

As shown in FIG. 7C, dongle 220 may detect multiple mobile devices 230, and may select one or more mobile devices 230 to receive the customer information. As shown by reference number 735, assume that dongle 220 determines to provide all customer information to employee mobile device 230, and determines to prevent any customer information from being provided to non-employee mobile device 230. As another example, dongle 220 may provide customer traffic information to non-employee mobile device 230 (e.g., as shown in FIG. 7A), and may provide all customer information to employee mobile device 230 (e.g., as shown in FIG. 7B). As another example, dongle 220 may provide customer traffic information to non-employee mobile device 230, and may provide the rest of the customer information (e.g., device repair information and inventory information) to employee mobile device 230.

As shown in FIG. 7D, assume that dongle 220 detects a first mobile device 230, and receives information indicating that the first mobile device 230 is moving and/or has a weak signal (e.g., a weak signal with dongle 220, a weak cellular signal, etc.). Further, assume that dongle 220 detects a second mobile device 230, and receives information indicating that the second mobile device 230 is stationary and/or has a strong signal. Based on this information, dongle 220 determines to transmit customer information to the second mobile device 230, as shown by reference number 740.

As indicated above, FIGS. 7A-7D are provided merely as an example. Other examples are possible and may differ from what was described with regard to FIGS. 7A-7D.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example through “opt-in” or “opt-out” processes as may be appropriate for the situation and type of information. Storage and use of personal information may be in an appropriately secure manner reflective of the type of information, for example, through various encryption and anonymization techniques for particularly sensitive information.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, a “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive information that identifies a set of conditions associated with providing customer information to mobile devices;
determine that the customer information is available for transmission to a mobile device;
determine that the mobile device is within a communication range of the device;
request, from the mobile device and based on determining that the mobile device is within the communication range, information that identifies one or more user communication preferences associated with providing the customer information to the mobile device;
receive, from the mobile device, the information that identifies the one or more user communication preferences;
determine whether the customer information is to be transmitted to the mobile device based on the one or more user communication preferences and the set of conditions; and
selectively provide the customer information to the mobile device based on determining whether the customer information is to be transmitted to the mobile device.

2. The device of claim 1, where the one or more processors are further to:
receive a device identifier from the mobile device;
determine that the mobile device is approved to receive customer information based on the device identifier; and
where the one or more processors, when requesting the information that identifies the one or more user communication preferences, are further to:
request the information that identifies the one or more user communication preferences based on determining that the mobile device is approved.

3. The device of claim 1, where the set of conditions identifies a delivery requirement that indicates a first preference for when the mobile device is to upload the customer information to a network storage device;
where the one or more user communication preferences indicates a second preference for when the mobile device is permitted to upload the customer information to the network storage device; and
where the one or more processors, when determining whether the customer information is to be transmitted to the mobile device, are further to:
determine whether the customer information is to be transmitted to the mobile device based on the first preference and the second preference.

4. The device of claim 1, where the customer information includes first customer information of a first type and second customer information of a second type;
where the one or more processors, when receiving information that identifies the set of conditions associated with providing the customer information to the mobile devices, are further to:
determine a first set of conditions for providing the first customer information;
determine a second set of conditions for providing the second customer information; and
where the one or more processors, when determining whether the customer information is to be transmitted to the mobile device, are further to:
determine whether the first customer information is to be transmitted to the mobile device based on the first set of conditions; and
determine whether the second customer information is to be transmitted to the mobile device based on the second set of conditions.

5. The device of claim 4, where the one or more processors, when selectively providing the customer information to the mobile device, are further to:
provide the first customer information to the mobile device based on determining that the one or more user communication preferences satisfy the first set of conditions; and
prevent the second customer information from being provided to the mobile device based on determining that the one or more user communication preferences do not satisfy the second set of conditions.

6. The device of claim 1, where the one or more processors are further to:
detect a plurality of mobile devices within the communication range,
the plurality of mobile devices including the mobile device; and
select the mobile device from the plurality of mobile devices.

7. The device of claim 1, where the one or more processors are further to:
provide an instruction to the mobile device,
the instruction causing the mobile device to upload the customer information to a network storage device.

8. A computer-readable medium storing instructions, the instructions comprising:
one or more instructions that, when executed by one or more processors, cause the one or more processors to:
determine a condition for providing customer information to a mobile device;
detect the mobile device;
request, from the mobile device and based on detecting the mobile device, information that identifies a user communication preference associated with providing the customer information to the mobile device;
receive, from the mobile device and based on the request, the information that identifies the user communication preference;
determine whether the customer information is to be provided to the mobile device based on the user communication preference and the condition; and
selectively provide the customer information and an instruction to the mobile device based on determining whether the customer information is to be provided to the mobile device,
the instruction causing the mobile device to relay the customer information to a network storage device.

9. The computer-readable medium of claim 8, where the condition indicates a first preference for when the mobile device is to upload the customer information to a network storage device;
where the user communication preference indicates a second preference for when the mobile device is permitted to upload the customer information to the network storage device; and
where the one or more instructions, that cause the one or more processors to determine whether the customer information is to be transmitted to the mobile device, further cause the one or more processors to:
determine whether the customer information is to be transmitted to the mobile device based on the first preference and the second preference.

10. The computer-readable medium of claim 8, where the customer information includes first customer information of a first type and second customer information of a second type;
where the one or more instructions, that cause the one or more processors to receive the information that identifies the condition, further cause the one or more processors to:
determine a first condition for providing the first customer information;
determine a second condition for providing the second customer information; and
where the one or more instructions, that cause the one or more processors to determine whether the customer information is to be transmitted to the mobile device, further cause the one or more processors to:
determine whether the first customer information is to be transmitted to the mobile device based on the first condition; and
determine whether the second customer information is to be transmitted to the mobile device based on the second condition.

11. The computer-readable medium of claim 10, where the one or more instructions, that cause the one or more processors to selectively provide the customer information to the mobile device, further cause the one or more processors to:
provide the first customer information to the mobile device based on determining that the user communication preference satisfies the first condition; and
prevent the second customer information from being provided to the mobile device based on determining that the user communication preference does not satisfy the second condition.

12. The computer-readable medium of claim 8, where the one or more instructions further cause the one or more processors to:
detect a plurality of mobile devices; and
where the one or more instructions, that cause the one or more processors to selectively provide the customer information to the mobile device, further cause the one or more processors to:
provide the customer information to a first mobile device of the plurality of mobile devices; and
provide the customer information to a second mobile device of the plurality of mobile devices.

13. The computer-readable medium of claim 8, where the one or more instructions further cause the one or more processors to:
detect a plurality of mobile devices;
where the one or more instructions, that cause the one or more processors to selectively provide the customer information to the mobile device, further cause the one or more processors to:
provide a first portion of the customer information to a first mobile device of the plurality of mobile devices; and
provide a second portion of the customer information to a second mobile device of the plurality of mobile devices,
the second portion being different from the first portion.

14. The computer-readable medium of claim 8, where the one or more instructions further cause the one or more processors to:
detect a plurality of mobile devices,
the plurality of mobile devices including the mobile device;
compare a characteristic associated with the plurality of mobile devices;
select the mobile device, from the plurality of mobile devices, based on comparing the characteristic; and
where the one or more instructions, that cause the one or more processors to request the information that identifies the user communication preference, further cause the one or more processors to:
request the information that identifies the user communication preference based on selecting the mobile device.

15. A method, comprising:
receiving, by a device, information that identifies a set of conditions associated with providing customer information to mobile devices within a communication range of the device;
determining, by the device, that the customer information is available for transmission to a mobile device;
detecting, by the device, the mobile device within a communication range of the device;
determining, by the device, that the mobile device is approved to receive the customer information based on detecting the mobile device;
requesting, by the device and from the mobile device, information that identifies a user communication preference associated with providing the customer information to the mobile device based on determining that the mobile device is approved;
receiving, by the device and from the mobile device, the information that identifies the user communication preference;
determining, by the device, that the customer information is to be transmitted to the mobile device based on the user communication preference and the set of conditions; and
provide the customer information to the mobile device based on determining that the customer information is to be transmitted to the mobile device to permit the mobile device to relay the customer information to a network storage device.

16. The method of claim 15, where providing the customer information causes the mobile device to upload the customer information to a network storage device.

17. The method of claim 15, where determining that the mobile device is approved to receive the customer information further comprises:
determining a device identifier associated with the mobile device;
comparing the device identifier to a stored identifier,
the stored identifier being identified in the set of conditions; and
where requesting the information that identifies the user communication preference further comprises:
requesting the information that identifies the user communication preference based on comparing the device identifier to the stored identifier.

18. The method of claim 15, where the set of conditions identifies a first preference for when the mobile device is to upload the customer information to the network storage device;
where the user communication preference identifies a second preference for when the mobile device is permitted to upload the customer information to the network storage device; and
where determining that the customer information is to be transmitted to the mobile device further comprises:
determining that the customer information is to be transmitted to the mobile device based on the first preference and the second preference.

19. The method of claim 15, further comprising:
detecting a plurality of mobile devices,
the plurality of mobile devices including the mobile device; and
where providing the customer information to the mobile device further comprises:
providing the customer information to the mobile device; and
providing the customer information to another mobile device of the plurality of mobile devices.

20. The method of claim 15, further comprising:
detecting a plurality of mobile devices,
the plurality of mobile devices including the mobile device;
where providing the customer information to the mobile device further comprises:
providing a first portion of the customer information to the mobile; and
providing a second portion of the customer information to another mobile device of the plurality of mobile devices,
the second portion being different from the first portion.
